(19) United States
(12) Patent Application Publication
(10) Pub. No.: US 2011/0181179 A1
(43) Pub. Date: Jul. 28, 2011

(54) Light Emitting Device

(75) Inventor: Jan Birnstock, Dresden (DE)

(73) Assignee: NOVALED AG, Dresden (DE)

(21) Appl. No.: 13/056,230

(22) PCT Filed: Jul. 30, 2009
(86) PCT No.: PCT/DE09/01068

§ 371 Date: Mar. 31, 2011

(30) Foreign Application Priority Data
Jul. 30, 2008 (DE) 102008035471.6

(51) Int. Cl. H01J 1/62

(52) U.S. Cl. 313/504

(57) ABSTRACT

The invention relates to a light-emitting device, in particular an illumination device, with a two-dimensional arrangement of separately formed lighting elements, each of which has a cover electrode and a base electrode as well as an organic region formed therebetween and in electrical contact with the cover electrode and the base electrode on a carrier substrate, whereby organic regions of adjacent lighting elements respectively are separated from one another by means of an associated intermediate region, a respective light outcoupling element optimizing the light outcoupling, coefficient of an associated lighting element, and an electrical series connection with at least one part of the lighting element, in which the cover electrode of a lighting element and the base electrode of an adjacent lighting element are electrically connected to one another via a connection, which is formed by the intermediate region between the lighting element and the adjacent lighting element.

### FIELD OF THE INVENTION

The invention relates to a light-emitting device, in particular, an illumination device.

### BACKGROUND OF THE INVENTION

Light-emitting devices are available in a variety of forms, in particular as illumination devices. A frequently occurring problem of light-emitting devices consists in efficiently outcouple the light produced in the device so that is also is useable for the respective desired application. Thus, it is known in connection with light-emitting organic diodes (OLED) that a good portion of the light produced in the component is captured in so-called substrate- and organic modes. With such components, typically a layer construction with a base electrode and a cover electrode as well as an organic region arranged therebetween and in electrical contact with the base electrode and the cover electrode is formed on a carrier substrate. According to the typical working principles, electrical charge carriers in the form of holes and electrons are injected in the organic region, in such a component, by means of application of an electrical voltage on the electrodes and recombined there with light emission into the so-called light-emitting region. The organic region is typically produced as a stack of layers made from one or more organic materials.

In two-dimensional illumination devices with an organic light-emitting region, it is known to form the organic region as a continuous layer. In the document WO 2008/001241 A2, a structured OLED is described, in which the organic region is formed on a uniform carrier substrate of the two-dimensional component as a continuous layer. For directed light emission, an assembly of lenses is positioned on a light-emission side of the two-dimensional component.

With another two-dimensional illumination device, in document EP 1 051 582 B2 in one embodiment, multiple separately formed lighting means are formed for so-called separated profile members, whereby the lighting means are embodied as electroluminescent light layers on the associated profile members, on which by means of ITO electrodes, an electrical voltage can be applied.

Document US 2008/117519 describes a top-emitting OLED, which includes a micro lens grid, whereby the micro lens grid is formed as hemispheres.

Document EP 1 396 676 A2 describes an illumination device, which includes multiple OLEDs connected in series.

For optimizing the outcoupling of the light produced in the light-emitting organic components, it was proposed to use outcoupling films on the light-emission sides of the component. However, this leads to minimal increase in efficiency. Typically, between 20 and 50% of light produced in the component can be outcoupled. Other known features relate to a roughening of the carrier substrate, the use of diffusion foil, the application of diffusion particles in the carrier substrate and the combination of such designs. However, only limited increases in efficiency were achieved.

### SUMMARY OF THE INVENTION

The object of the invention is to produce a light-emitting device, in particular an illumination appliance, which has an improved light outcoupling efficiency.

This object is solved according to the present invention by a light-emitting device, in particular an illumination appliance, according to claim 1. Advantageous embodiments of the invention are the subject matter of the dependent claims.

The invention includes the idea of a light-emitting device, in particular an illumination appliance, with a two-dimensional arrangement of separately formed lighting elements, which have respectively a cover electrode and a base electrode, as well as an organic region formed therebetween and in electrical contact with the cover electrode and the base electrode, whereby organic regions of adjacent lighting elements, are respectively separated from one another by means of an associated intermediate region, a respective light outcoupling element optimizing the light outcoupling efficiency of an associated lighting element, which is arranged on a light-emitting side of the lighting element, and an electrical series connection with at least a part of the lighting elements, in which the cover electrode of an lighting element and the base electrode of an lighting element adjacent thereto are electrically connected to one another via connection, which is formed by the intermediate region between the lighting element and the adjacent lighting element.

### BRIEF DESCRIPTION OF THE DRAWINGS

The invention will be described in greater detail by means of preferred embodiments with reference to the figures. In the figures:

FIG. 1 shows a schematic illustration of a two-dimensional arrangement with multiple lighting elements, which are formed separately from one another on a common carrier substrate and are arranged according to a honeycomb pattern;

FIG. 2 shows a further schematic illustration of the two-dimensional arrangement with the multiple lighting elements of FIG. 1, whereby on each lighting element a light outcoupling element is arranged; and

FIG. 3 shows a schematic illustration of an arrangement with two lighting elements, which are connected to one another in an electrical series connection.

### DETAILED DESCRIPTION OF THE EMBODIMENTS

According to an embodiment of the invention, the light outcoupling elements can be formed for the lighting elements individually or for multiple lighting elements, can be combined commonly into groups. With the embodiment of a common formation for multiple or all lighting elements, one or more integrated light outcoupling components are provided, which include in a two-dimensional arrangement the multiple light outcoupling elements. The lighting elements themselves can be formed on a common substrate or on associated partial substrates.

The electrical connection can be formed in the intermediate region directly on the substrate or on one or more layers, which layers are deposited on the carrier substrate.

With the aid of the individual association of a light outcoupling element to the respective lighting element in the two-dimensional arrangement, a selectively optimized outcoupling for each of the lighting elements is possible individually. Material savings for the lighting elements are produced in the two-dimensional arrangement of organic regions spaced from one another and separately formed. The intermediate regions remaining herebewteen above the common carrier substrate are then used for a space-saving, electrical series connection of the lighting elements, in which electrical connections are guided through the intermediate regions, which connect the cover electrode of a lighting element and the base electrode of a lighting element adjacent hereto. In this manner, the remaining intermediate regions between the individual organic regions are used for electrical connection of the lighting elements.

All of the lighting elements or only a part of them can be connected in series. Also a combination of the series connection with a parallel connection of other lighting elements can be provided. In this manner, the operating voltage of the component can be adapted to the available supply voltage. In addition, by means of the series connection, a complete failure of the component by burning out of a lighting element is prevented.

In addition to an efficient use of the substrate surface in the arrangement and the connection of the lighting elements as well as the high efficiency of the components, a further advantage with the production of the components is provided. For the proposed structure, no fine masking of the organic regions or the electrodes is necessary. This simplifies the production and actually enables a roll-to-roll processing.

A preferred further embodiment of the invention contemplates that the respective light outcoupling element is formed as an optical lens. In this manner, an optimized light outcoupling is achieved. In addition, the Lambertian radiation characteristics thus can he implemented for the component, which in particular is desired for illumination elements on the basis of OLEDs. Other light outcoupling elements can be provided, preferably are those which outcouple the light freely from a specific angle-range focusing. For illumination applications with OLEDs, these should be used for this reason, because they emit a very “soft” light homogeneously and without sharp shadows or bright spots in the space.

In a functional embodiment of the invention, it can be provided that the respective optical lens is formed with dome-shaped cap. It can be a hemispherical shell or a filled hemisphere. The dome-shaped cap which may be provided as a spherical cap shape is particularly advantageous with bottom-emitting geometries, when the thickness of the substrate compared to the diameter of the lighting element is not insignificant. Then instead of a hemispherical FORM, the spherical cap form can be provided, whose height compared to the hemisphere is reduced to approximately the substrate thickness. Also other forms of the outcoupling element can be used, for example flattened spherical caps, oval spherical caps or caps of rotation ellipsoids.

An advantageous embodiment of the invention contemplates that for the ratio between the diameter of a respective lighting element surface of the lighting element and the diameter of the associated optical lens with hemispherical shape, a value of approximately at least 0.1 to at most approximately 0.9 is formed, preferably of approximately at least 0.5 to at most approximately 0.8. In this manner, the light outcoupling is further optimized. Simultaneously, the substrate surface is used effectively for the light-emitting device. Thus, a ratio of 0.8 corresponds to a surface use of approximately 77% assuming an arrangement of the lighting elements in a honeycomb pattern. A ratio of 0.5 corresponds always to a surface use of over 30%. This also is roughly the filling factor of active-matrix displays on the basis of OLEDs.

Preferably, a further embodiment of the invention contemplates that a lens center point of the optical lens is arranged over a surface center point of the organic region of the associated lighting element. In this manner, the light outcoupling is further optimized.

A functional embodiment of the invention contemplates that the respective optical lens is a Fresnel lens. In this manner, in particular, a very flat structure is supported. In particular, when using larger lighting elements, the use of the Fresnel lens is sensible. Large lighting elements in turn facilitate the processing, since the requirements of masking accuracy and adjustment are fewer.

With an advantageous embodiment of the invention, it can be provided that the light outcoupling elements of adjacent lighting elements are formed to laterally abut one another, selectively up to overlapping in sections. By means of the sectional overlapping, a higher fill factor can be achieved. If for example circular lighting elements are used, which are arranged in a honeycomb pattern, an increase of the fill factor to approximately 33% and more can be achieved by means of the partial overlapping of the light outcoupling elements, while the efficiency increase remains almost unaffected. By means of the increased fill factor, the individual lighting elements can be operated with less brightness, which in turn increases the longevity of the components.

A further embodiment of the invention can provide that the lighting elements are distributed accordingly in the two-dimensional arrangement of a honeycomb pattern. In this manner, a maximum fill factor is realized.

A preferred further embodiment of the invention contemplates that the two-dimensional arrangement is formed with regard to a surface region taken by the lighting elements with a fill factor of approximately 25% to approximately 75%. The fill factor refers to the ratio of the active surface, which is the surface occupied by the lighting elements, to the total surface of the light-emitting device in the area of the lighting elements.

In a functional embodiment of the invention, it can be provided that the lighting elements are formed, with regard to their respective lighting element surfaces, with dimensions of approximately 100 μm to approximately 1 cm, preferably with dimensions of approximately 1 mm to approximately 1 cm. If the diameter of the lighting element surface is greater than approximately 1 cm, a vertical extension of the lighting outcoupling elements of more than approximately 5 mm is provided, in order to permit optimal outcoupling. Only the use of a Fresnel lens represents an exception here, which may be costlier in technical respects. Individual lighting elements with less than a lighting element surface of 100 μm hardly make sense, since then based on the substrate thickness, which in practice is greater than approximately 100 μm, a highly efficient outcoupling of the light is not possible.

An advantageous embodiment of the invention contemplates that the organic regions are formed to emit light of different colors. The emission of different colors is realized for the lighting elements, in that different emitter materials, which emit light with different wavelengths, are integrated in the organic regions. For this purpose, different emitter materials are available, which are known as such in different embodiments. In this manner, it is possible to make components for illumination, whose color is adjustable. Regions, which emit light of different colors, are separately controlled.

Preferably, a further embodiment of the invention contemplates that the lighting elements are formed according to one of the following types of structure: by the component emitting the cover electrode or by the component emitting the base electrode.

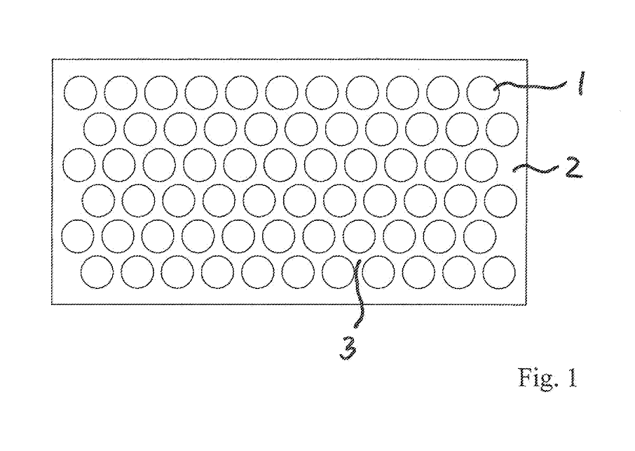

FIG. 1 shows a schematic illustration of a two-dimensional arrangement with multiple lighting elements 1, which are formed on a common carrier substrate 2 separately from one another and are arranged according to a honeycomb pattern.

The lighting elements I are formed in the illustrated embodiment as an organic, light-emitting diode (OLED), in which on the carrier substrate 2 in the region of the respective lighting element, a layer arrangement with a base layer formed on the carrier substrate 2 and a cover electrode as well as an organic region formed herebewteen and in electrical contact with the base electrode and the cover electrode. These types of light-emitting organic components are known as such in different embodiments. The production of the organic region takes place, for example, by means of vacuum evaporation of the provided organic materials. Particular advantageous is the use of light emitting organic components in the so-called pin-embodiment, which in particular is characterized in that electrically doped charge carrier-transport layers are provided, which based on the electrical doping, support the injection and the transport of the electrical charge carriers, namely holes and electrons, in the organic region, so that the component efficiency is increased. However, also other forms of light-emitting organic components can be used for formation of the lighting elements 1. An electrically doped layer is produced, for example, by means of co-evaporation of a matrix material and a doping material.

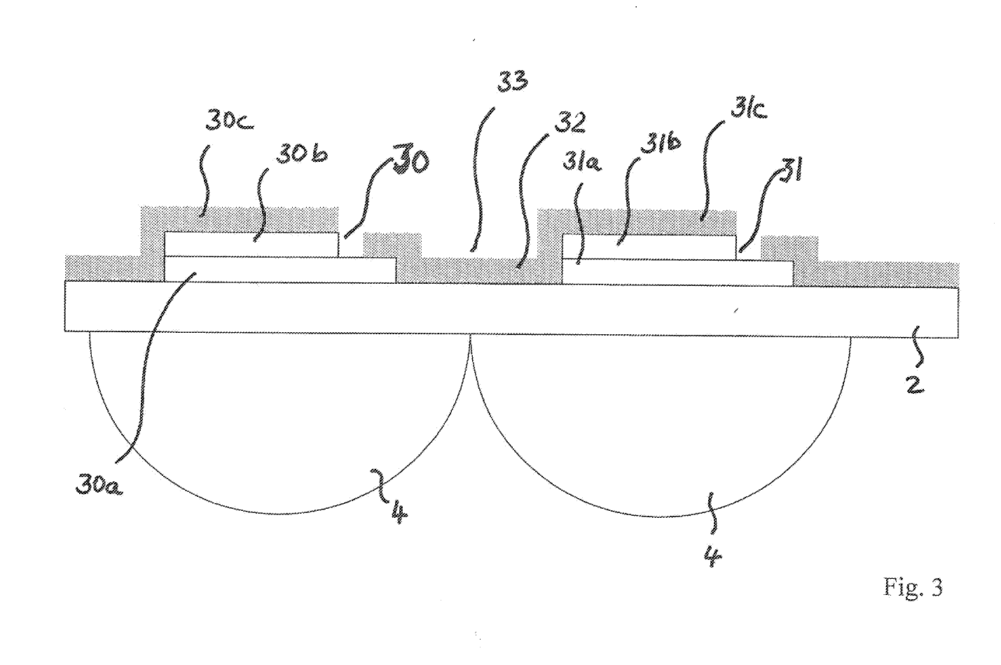

According to FIG. 1, the lighting elements 1 are embodied on the common carrier substrate 2 as lighting elements 1 separated from one another by intermediate regions 3, which means in particular that the organic regions of the light-emitting organic components are made as separated regions on the carrier substrate 2. The separated structure of the lighting elements 1 is realized with the production of the two-dimensional arrangement, for example by means of mask technology known as such in connection with the layer deposition. The lighting elements I are arranged in an electrical series connection, in which electrical connections are produced through the intermediate regions 3 between adjacent lighting elements, which is explained in greater detail below with reference to FIG. 3.

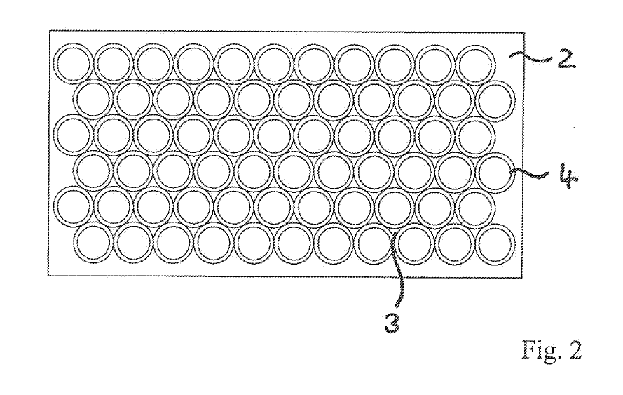

FIG. 2 shows a further schematic representation of the two-dimensional arrangement of lighting elements I from FIG. 1, whereby now each of the lighting elements I is provided with an associated light outcoupling element 4, with which on a light emitting side of the lighting elements 1, the efficiency for the outcoupling of the light produced in the respective light element 1 is optimized. The light outcoupling elements 4 are embodied as an optical lens in the illustrated embodiment, namely an optical lens with a hemispherical shape (compare FIG. 3 below). FIG. 2 shows that adjacent light outcoupling elements 4 are arranged to abut one another. A sectional overlapping in edge regions of the light outcoupling elements 4 is provided for adjacent lighting elements 1 (not shown).

With the aid of the optical lenses provided as hemisphere shaped in the embodiment, an improved light outcoupling is achieved individually for the lighting elements 1. Table 1 shows comparatively in which range an efficiency increase is possible. Instead of the hemisphere shaped optical lenses, also Fresnel lenses with the same optical properties can be used.

TABLE 1

| D_{lighting element}/Dₗₑₙₛ | 0.1 | 0.5 | 0.7 | 1 | Flat glass |
|---|---|---|---|---|---|
| Layer thickness ETL 33 | 0.97 | 0.95 | 0.74 | 0.52 | 0.56 |
| nm | | | | | |
| Layer thickness ETL 117 | 0.97 | 0.95 | 0.77 | 0.5 | 0.14 |
| nm | | | | | |
| Layer thickness ETL 168 | 0.97 | 0.94 | 0.73 | 0.5 | 0.46 |
| nm | | | | | |
| Layer thickness ETL 198 | 0.97 | 0.94 | 0.73 | 0.51 | 0.57 |
| nm | | | | | |
| Layer thickness ETL 209 | 0.97 | 0.95 | 0.74 | 0.52 | 0.58 |
| nm | | | | | |
| Layer thickness ETL 230 | 0.97 | 0.95 | 0.75 | 0.52 | 0.53 |
| nm | | | | | |
| Lambert's Law | 0.96 | 0.93 | 0.74 | 0.5 | 0.41 |
| Efficiency increase | +134% | +127% | +80% | +22% | 0 |
| relative to flat glass | | | | | |

Table 1 shows the outcoupling efficiency as well as a comparison of its improvement for different ratios of the respective diameter of the lighting element I to the diameter of the hemispherical shaped optical lens 4, specifically ratio values of 0.1, 0.5, 0.7 as well as 1. In practice, preferred values lie in the range of approximately 0.4 to approximately 0.8. It is provided that significant efficiency increases in comparison to flat glass arranged on the lighting elements 1 (compare last column in Table 1) can be achieved.

The results are represented for different thicknesses of an electron-transport layer (ETL) encompassed by the lighting elements 1, which respectively are embodied as a light-emitting organic diode. It is provided by implication that the improvement of the light outcoupling is to the greatest possible extent independent from the thickness of the ETL. The described arrangement can be used therefore for many different stacking arrangements of organic light-emitting components, in particular OLEDs, for example, monochromatic, white, stacked, top- and bottom-emitting, inverted and hybrid OLEDs. As representative values for the improvement of the outcoupling efficiency to be expected, the values in the line “Lambert's Law” can be considered, since OLEDs have an emission characteristic for the majority of illumination applications, which approach the Lambert law.

It is provided in the schematic illustrations of FIGS. 1 and 2 that the center of curvature of the light outcoupling element 4 is arranged respectively over the surface center point of the lighting element 1. For the size of the lighting element 1, specific dimensions of approximately 100 μm to approximately 1 cm, preferably of approximately 1 mm to approximately 1 cm are provided.

The lighting element 1 can be formed with organic regions, which emit either light of the same color or different colors. Different color portions can be determined relative to its proportion that blends in the sum of white light radiation.

FIG. 3 shows a schematic illustration of a section from the two-dimensional arrangement in FIGS. 1 and 2. On the common carrier substrate 2, two lighting elements 30, 31 are arranged, which have an organic region 30b, 31b over a base electrode 30a, 31a, as well as a cover electrode 30c, 31e. An electrical series connection is formed, in which the cover electrode 31c is connected with the base electrode 30a via an electrical connection 32, which runs through an intermediate region 33 between the two lighting elements 30, 31.

The lighting elements 30, 31 shown in FIG. 3 are made in an embodiment emitting light through the respective base electrode 30a, 31a, which is why associated light outcoupling elements 4 are arranged underneath the carrier substrate 2. In a top-emitting arrangement, the light outcoupling elements 4 in contrast are arranged above the carrier substrate 2.

The features of the invention disclosed in the preceding disclosure, the claims and the drawings can be significant individually as well as in any combination for the implementation of the invention in its various embodiments.

1. A light-emitting device comprising:
a two-dimensional assembly of least two lighting elements, wherein each lighting element comprises a cover electrode, a base electrode on a carrier substrate, and an organic region arranged therebetween, wherein the organic region is in electrical contact with the cover electrode and the base electrode, and wherein the organic regions of adjacent lighting elements are separated from one another by an associated intermediate region;
a light outcoupling element, wherein the light outcoupling element optimizes the respective light outcoupling efficiency of an associated lighting element, and wherein the light outcoupling element is arranged on a light emission side of the associated lighting element; and
an electrical series connection, wherein the cover electrode of at least one lighting element and the base element of an adjacent lighting element are electrically connected to one another via a connection, wherein the connection is in the intermediate region between the at least one lighting element and the lighting element adjacent thereto.

2. The device according to claim 1, wherein the light outcoupling element comprises an optical lens.

3. The device according to claim 2, wherein the optical lens comprises a spherical cap shape.

4. The device according to claim 2, wherein the ratio between the diameter of a lighting element surface of the associated lighting element and the diameter of the associated optical lens with hemispherical shape is approximately about 0.1 to about 0.9.

5. The device according to claim 2, wherein a lens center point of the optical lens is arranged over a surface center point of the organic region of the associated lighting element.

6. The device according to claim 2, wherein the optical lens comprises a Fresnel lens.

7. The device according to claim 1, wherein the light outcoupling elements of at least two adjacent lighting elements laterally abut one another.

8. The device according to claim 1, wherein the at least two lighting elements are distributed in a honeycomb pattern.

9. The device according to claim 1, wherein the two-dimensional assembly comprises a fill factor of about 25% to about 75% relative to a surface region occupied by the at least two lighting elements.

10. The device according to claim 1, wherein the at least two lighting elements comprise respective lighting element surfaces with dimensions of about 100 μm to about 1 cm.

11. The device according to claim 1, wherein the organic regions of the at least two lighting elements emit light of different colors.

12. The device according to claim 1, wherein the at least two lighting elements are formed according to at least one of the following construction types: by the component emitting the cover electrode and by the component emitting the base electrode.
